(19) United States
(12) Patent Application Publication
(10) Pub. No.: US 2014/0136647 A1
(43) Pub. Date: May 15, 2014

(54) ROUTER AND OPERATING METHOD THEREOF

(71) Applicant: Electronics and Telecommunications Research Institute, Daejeon (KR)

(72) Inventors: Byong Kwon MOON, Daejeon (KR); Byung Joon LEE, Daejeon (KR); Hong Seok JEON, Daejeon (KR)

(73) Assignee: Electronics and Telecommunications Research Institute, Daejeon (KR)

(21) Appl. No.: 14/073,508

(22) Filed: Nov. 6, 2013

(30) Foreign Application Priority Data
Nov. 14, 2012 (KR) 10-2012-0128847

(51) Int. Cl. H04L 29/08

(52) U.S. Cl. CPC H04L 67/327; H04L 67/2842
USPC 709/214

(57) ABSTRACT

An exemplary embodiment provides a router including: a number calculating unit configured to count an accumulated request number corresponding to a plurality of previously requested contents and a request number of a request signal for an arbitrary content which is currently input; a probability calculating unit configured to calculate an arbitrary probability value for the arbitrary content based on the accumulated request number and the request number; and a policy determining unit configured to determine whether to store the arbitrary content which is provided to an arbitrary terminal which transmits the request signal from an arbitrary content server, based on the arbitrary probability value and a set reference probability value.

### CROSS-REFERENCE TO RELATED APPLICATIONS

This application claims priority to and the benefit of Korean Patent Application No. 10-2012-0128847 filed in the Korean Intellectual Property Office on Nov. 14, 2012, the entire contents of which are incorporated herein by reference.

### TECHNICAL FIELD

Embodiments relate to a router and an operating method thereof, and more specifically, to a router which easily determines whether to store an arbitrary content which is provided in accordance with a number of requests of a request signal for the arbitrary content and an operating method thereof.

### BACKGROUND ART

Generally, in a wireless Internet terminal or a terminal device in which wireless Internet is available, such as a mobile phone or a PDA, a content is received from a server, stored in a memory, and displayed on a screen. In this case, the contents which are received from the server are collectively stored in the memory. If the capacity of the memory is full, the contents are deleted sequentially from the oldest content.

In order to read out the content from the memory to be reproduced without being transmitted from the server again when the content needs to be reproduced and displayed again, the content is stored in the memory. In this case, it needs to be checked whether the content (for example, a web page) is expired. If the content stored in the memory is different from a content which is currently provided from a server, that is, the content which has been stored in the memory is updated, the content cannot be used. Therefore, the content is transmitted from the server, stored in the memory and reproduced again.

In such a content management method of the related art, all contents are stored in the memory so that not only contents which are frequently called to be displayed, but also contents which are not so frequently called to be displayed are stored in the memory. As a result, the memory capacity is not efficiently used and a content which is frequently reproduced is deleted due to the limitation in the capacity of the memory in many cases so that the content needs to be transmitted from the server again in many cases. If the content is frequently transmitted from the server to be reproduced, it takes considerable time to reproduce the content, which may cause a user to avoid using the wireless Internet.

### SUMMARY OF THE INVENTION

The embodiments have been made an effort to provide a router which easily determines whether to store an arbitrary content which is provided in accordance with a number of requests of a request signal for the arbitrary content and an operating method thereof.

A router according to an embodiment includes: a number calculating unit configured to count a plurality of accumulated request numbers corresponding to a plurality of previously requested contents and a request number of a request signal for an arbitrary content which is currently input; a probability calculating unit configured to calculate an arbitrary probability value for the arbitrary content based on the plurality of accumulated request numbers and the request number; and a policy determining unit configured to determine whether to store the arbitrary content which is provided to an arbitrary terminal which transmits the request signal from an arbitrary content server, based on the arbitrary probability value and a set reference probability value.

An operating method of a router according to an embodiment includes: transmitting a request signal to a content server which provides an arbitrary content when a request signal for the arbitrary content is transmitted from a terminal device; counting a plurality of accumulated request numbers corresponding to a plurality of previously requested contents and a request number of a request signal for an arbitrary content which is currently input; calculating an arbitrary probability value for the arbitrary content based on the plurality of accumulated request numbers and the request number; and determining whether to store the arbitrary content which is provided to an arbitrary terminal which transmits the request signal from an arbitrary content server, based on the arbitrary probability value and a set reference probability value.

The router and the operating method thereof according to the embodiments may efficiently utilize a limited memory and optimize a performance of the router by determining an order of priority of contents to be stored.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a system diagram illustrating a network system which includes a router according to an exemplary embodiment.

FIG. 2 is a control block diagram of the router according to the exemplary embodiment.

FIG. 3 is a flow chart illustrating an operating method of a router according to an exemplary embodiment.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In the description of components of an exemplary embodiment, a component having the same name may be denoted by a different reference numeral in some drawings but may be denoted by the same reference numeral even in different drawings. However, even in this case, it does not mean that the component has different functions depending on the exemplary embodiment or the components have the same function in the different exemplary embodiments but the function of each of the components may be determined based on the description of the components in the corresponding exemplary embodiment.

Further, if it is considered that description of related known configuration or function may cloud the gist of the present invention, the description will be omitted.

Further, in the description of the components of the exemplary embodiment, a terminology such as a first, a second, A, B, (a), (b) may be used. The terminology is used to distinguish a component from the other component but a nature or an order of the component is not limited by the terminology. If it is described that a component is “connected” or “coupled” to the other component, it is understood that the component is directly connected or coupled to the other component but another component may be “connected” or “coupled” between the components.

Hereinafter, a router and an operating method thereof according to an exemplary embodiment will be described with reference to accompanying drawings.

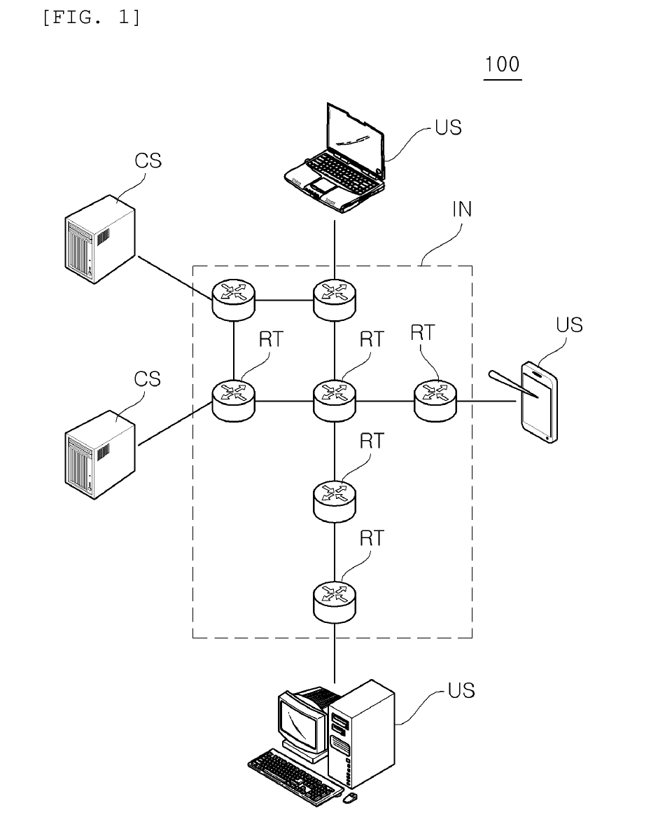

FIG. 1 is a system diagram illustrating a network system which includes a router according to an exemplary embodiment. The network system 100 may include a plurality of content servers CS which provides a content, a plurality of clients US (hereinafter, referred to as a “terminal device”) which requests to provide the content and displays a transmitted content, and a plurality of routers RT which sets a path in a network IN of the request and the content which is provided by the content servers CS when the content is requested to be provided.

In the exemplary embodiment, it is described that the plurality of content servers CS is two, the plurality of terminal devices US is three, and the plurality of routers RT is seven, but the number of the above components and the connected status are not limited.

Further, at least one of the plurality of content servers CS may provide the same content as at least one of the other content servers but it is not limited thereto.

In the exemplary embodiment, it is considered that two content servers CS provide different contents.

When the terminal device US is connected, the content server CS provides various contents to the terminal device US and manages setting information which is set by the terminal device US.

The terminal device US is a terminal which is connected to the content server CS to use various contents which are provided from the content server US. Such a terminal device US may collectively refer to all user terminals which use an IP (internet protocol) such as a personal computer, a mobile notebook computer, and portable terminal.

The terminal device US may be classified into a ATM system and an IP system in accordance with the characteristic of the line which is connected to the network IN. In the meantime, the terminal device US allows the user who joins an online content access control service to create a usage time zone, an amount of used time, and a complex control standard therefor and interworks the control standard with a control function selected for every protocol of the content based on control information set by the user.

In the exemplary embodiment, the network IN logically refers to a function as an interconnection passage in which signals flow between components including the content server US and the terminal device US and physically refers to a wired or wireless network including a number of cables. The network IN refers to a group of nets in which communication networks are interwork with each other and is an assembly of huge worldwide communication nets including a type which interconnects small size communication networks such as a LAN. The network IN includes a plurality of routers RT and the plurality of routers RT sets an address value required to build a communication line with a content server CS to which a specific terminal device US among the plurality of terminals US is connected at an end terminal of a network which is a physical configuration of the network IN.

That is, the router RT receives the address value of the content server CS to which the terminal device 20 is connected from the other router RT which configures the network IN and builds the communication line for data communication between the terminal device US and the content server CS. The router RT includes a SER (service edge router) which routes an IP series terminal US and an NAS (network access server) or a LAC (L2TP access concentrator) which routes an ATM series terminal US.

In this case, the router RT determines whether to cache the content in accordance with a caching policy which is set for the content which is transmitted to the terminal device US to temporarily cache the content and delete at least one of the contents which have been already cached.

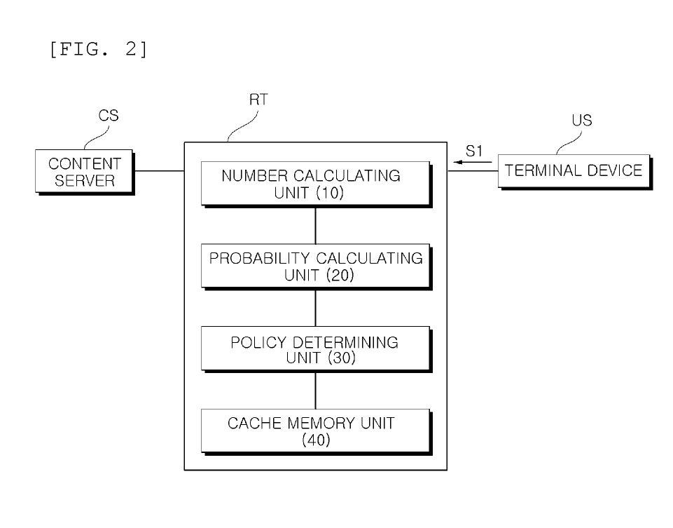

The router RT will be described in detail with reference FIG. 2.

FIG. 2 is a control block diagram of the router according to the exemplary embodiment.

FIG. 2 is a control block diagram illustrating a control configuration of any one of a plurality of routers RT illustrated in FIG. 1 and the control configuration of the one router may be same as or different from that of at least one of the plurality of routers RT, but is not limited to any specific configuration.

The router RT may include, when a request signal s1 for an arbitrary content is input from the terminal device US, a number calculating unit 10 configured to count a plurality of accumulated request numbers corresponding to a plurality of previously requested contents and a request number of a request signal for an arbitrary content which is currently input, a probability calculating unit 20 configured to calculate an arbitrary probability value for the arbitrary content based on the plurality of accumulated request numbers and the request number; a policy determining unit 30 configured to determine whether to cache an arbitrary content which is provided from the content server, based on the arbitrary probability value and a set reference probability value; and a cache memory unit 40 configured to cache at least one content among the plurality of contents.

The number calculating unit 10 may transfer the plurality of accumulated request number obtained by counting respective request numbers for previous request signals which are input prior to inputting a request signal s1 for the arbitrary content to the router to the probability calculating unit 20. The probability calculating unit 20 calculates a total accumulated request number obtained by adding the plurality of accumulated request numbers and divides the request numbers by the total accumulated request number to calculate the arbitrary probability value.

Further, if the accumulated number for a predetermined number of contents stored in the cache memory unit 40 is equal to or larger than the set reference number, the probability calculating unit 20 calculates a predetermined number of content probability values for the predetermined number of contents to transfer the content probability values to the policy determining unit 30.

If the arbitrary probability value is equal to or higher than the reference probability value, the policy determining unit 30 stores the arbitrary content provided from the content server CS in the cache memory unit 40 and provides the arbitrary contents to the terminal device US which requests the arbitrary contents.

Further, the policy determining unit 30 compares the accumulated number for the predetermined number of contents transmitted from the probability calculating unit 20 with a deletion probability value to manage the memory of the cache memory unit 40.

That is, the policy determining unit 30 may delete contents having a content probability value, among the predetermined number of content probability values, which is equal to or less than a set deletion probability value from the cache memory unit 40.

According to the above-described method or another method, the policy determining unit 30 compares the predetermined number of content probability values and deletes a content having a lowest content probability value from the cache memory unit 40, but the invention is not limited thereto.

For example, contents “a” and “b” are provided to one of two content servers CS and contents “c” and “d” are provided to the other one of the content servers CS. The contents “a”, “b”, and “c” are requested to the cache memory unit 40 of the router RT once, three times and twice as accumulated request numbers, respectively. The contents “a”, “b”, and “c” are stored in the cache memory unit 40. The operation of the router RT will be described below.

If a request signal s1 for the content “a” is input from the terminal device US_a, the number calculating unit 10, when the accumulated request number of the contents “a”, “b”, and “c” is “one”, “three”, and “two”, respectively, the content “a” is counted once with two accumulated request numbers.

In this case, the probability calculating unit 20 calculates the probability value for the content “a” with the total accumulated request number obtained by adding the accumulated request numbers of the contents “a”, “b”, and “c”.

That is, the probability calculating unit 20 divides the accumulated request numbers, 2, for the content “a” by the accumulated request numbers, 7, of the contents “a”, “b”, and “c” to calculate the probability value for the content “a”, that is, 2/7 is 0.236.

In this case, if the probability value calculated in the probability calculating unit 20, that is, 0.286 is equal to or larger than the set reference probability value, the policy determining unit 30 stores the content “a” input from the contents CS to transmit the content “a” to the terminal device US.

Therefore, the network system according to the embodiments may efficiently utilize a limited memory and optimize a performance of the router by determining an order of priority of contents which are stored in the router.

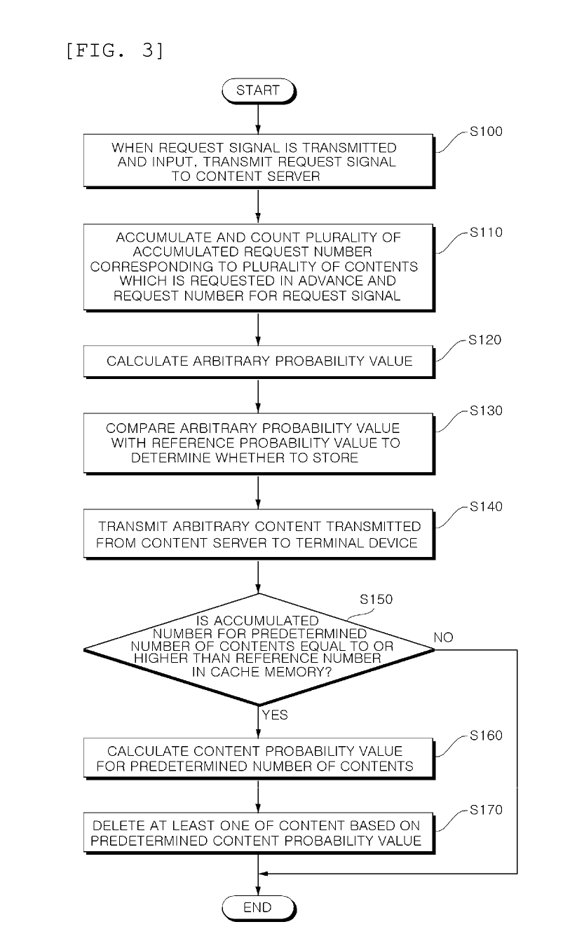

FIG. 3 is a flow chart illustrating an operating method of a router according to an exemplary embodiment.

FIG. 3 will be described using the components and reference numerals illustrated in FIGS. 1 and 2.

Referring to FIG. 3, if a request signal for an arbitrary content is transmitted from a terminal device US, in step S100, the router operating method transmits the request signal to a content server CS which provides the arbitrary content.

That is, if a request signal for an arbitrary content is transmitted from the terminal device US which is connected to the network IN, the router RT transmits an address value of the content server SC which provides the arbitrary content to another router RT which configures the network IN to build a communication line for data communication between the terminal device US and the content server SC and transmit the arbitrary content to the content server CS.

In step S110, the router counts the plurality of accumulated request numbers corresponding to the plurality of contents which is requested in advance and the request number for the arbitrary content and in step S120 calculates an arbitrary probability value for the arbitrary content based on the plurality of accumulated request numbers and the request number.

That is, the number calculating unit 10 of the router RT may transfer the plurality of accumulated request numbers obtained by counting respective request numbers for previous request signals which are input prior to inputting the request signal for the arbitrary content to the router to the probability calculating unit 20.

Further, the probability calculating unit 20 calculates a total accumulated request number obtained by adding the plurality of accumulated request numbers and divides the request numbers by the total accumulated request number to calculate the arbitrary probability value.

In step S130, it is determined whether to store the arbitrary content provided from the content server CS based on the arbitrary probability value and the set reference probability value and in step S140, the arbitrary content is transmitted to the terminal device US.

That is, if the arbitrary probability value is equal to or higher than the reference probability value, the policy determining unit 30 of the router RT stores the arbitrary content provided from the content server CS in the cache memory unit 40. In contrast, if the arbitrary probability value is lower than the reference probability value, the policy determining unit 30 of the router RT does not store the arbitrary content provided from the content server CS in the cache memory unit 40 and provides the arbitrary content to the terminal device US which requests the arbitrary content.

Before or after any one step among the above-mentioned steps S100 to S140, in step S150, it is determined whether the accumulated number of a predetermined number of contents among the plurality of contents stored in the cache memory 40 is higher than a reference number and if the accumulated number is equal to or larger than the reference number as a result of determination, in step S160, the predetermined content probability value for a predetermined number of contents is calculated. Further, in step S170, at least one of the predetermined number of contents is deleted from the cache memory unit 40.

That is, the policy determining unit 30 compares the accumulated number for the predetermined number of contents transmitted from the probability calculating unit 20 with a deletion probability value to manage the memory of the cache memory unit 40.

The policy determining unit 30 may delete contents having a content probability value, among the predetermined number of content probability values, which is equal to or less than a set deletion probability value from the cache memory unit 40. According to the another method which is different from the above-described method, the policy determining unit 30 compares the predetermined number of content probability values and deletes a content having a lowest content probability value from the cache memory unit 40, but the invention is not limited thereto.

The exemplary embodiments of the present invention have been described in detail, but it is obvious to those skilled in the art that various changes or modifications may be made without departing from the spirit and scope of the present invention as set out in the accompanying claims. Therefore, further modification of embodiments of the present invention is not departing from the description of the present invention.

What is claimed is:

1. A router, comprising:
a number calculating unit configured to count a plurality of accumulated request number corresponding to a plurality of previously requested contents and a request number of a request signal for an arbitrary content which is currently input;
a probability calculating unit configured to calculate an arbitrary probability value for the arbitrary content based on the plurality of accumulated request numbers and the request number; and
a policy determining unit configured to determine whether to store the arbitrary content which is provided to an arbitrary terminal which transmits the request signal from an arbitrary content server, based on the arbitrary probability value and a set reference probability value.

2. The router of claim 1, wherein the probability calculating unit calculates a total accumulated request number obtained by adding the plurality of accumulated request numbers and divides the request number by the total accumulated request number to calculate the arbitrary probability value.

3. The router of claim 1, further comprising:
a cache memory in which a predetermined number of contents among the plurality of contents is stored.

4. The router of claim 3, wherein if the arbitrary probability value is equal to or higher than the reference probability value, the policy determining unit stores the arbitrary content in the cache memory unit.

5. The router of claim 3, wherein if the accumulated number for the predetermined number of contents is equal to or higher than the set reference number, the probability calculating unit calculates a predetermined number of content probability value for the predetermined number of contents.

6. The router of claim 5, wherein the policy determining unit deletes contents having a content probability value, among the predetermined number of content probability values, which is equal to or less than a set deletion probability value from the cache memory unit.

7. The router of claim 5, wherein the policy determining unit compares the predetermined number of content probability value to delete a content having the lowest content probability value from the cache memory unit.

8. A router operating method, comprising:
transmitting a request signal to a content server which provides an arbitrary content when a request signal for the arbitrary content is transmitted from a terminal device;
counting a plurality of accumulated request numbers corresponding to a plurality of previously requested contents and a request number of a request signal for an arbitrary content which is currently input;
calculating an arbitrary probability value for the arbitrary content based on the plurality of accumulated request numbers and the request number; and
determining whether to store the arbitrary content which is provided to an arbitrary terminal which transmits the request signal from an arbitrary content server, based on the arbitrary probability value and a set reference probability value.

9. The router operating method of claim 8, wherein the calculating calculates a total accumulated request number obtained by adding the plurality of accumulated request numbers and divides the request number by the total accumulated request number to calculate the arbitrary probability value.

10. The router operating method of claim 8, wherein if the arbitrary probability value is equal to or higher than the reference probability value, in the determining, the arbitrary content is stored in the cache memory unit or if the arbitrary probability value is lower than the reference probability value, the arbitrary content is not stored in the cache memory unit.

11. The router operating method of claim 8, further comprising: after the determining,
transmitting the arbitrary content to the terminal device.

12. The router operating method of claim 8, further comprising: after the determining,
determining whether an accumulated number of a predetermined number of contents among the plurality of contents stored in the cache memory is equal to or larger than the set reference number,
if the accumulated number is equal to or larger than the reference number as a result of the determination, calculating a predetermined number of content probability value for the predetermined number of contents; and
deleting at least one of the predetermined number of contents in the cache memory based on the predetermined number of content probability values.

13. The router operating method of claim 12, wherein: the deleting deletes contents having a content probability value, among the predetermined number of content probability values, which is equal to or less than a set deletion probability value from the cache memory unit.

14. The router operating method of claim 12, wherein: the deleting compares the predetermined number of content probability values to delete a content having the lowest content probability value from the cache memory unit.
